(19) United States
(12) Patent Application Publication
(10) Pub. No.: US 2022/0207419 A1
(43) Pub. Date: Jun. 30, 2022

(54) PREDICTIVE ENGINE FOR TRACKING SELECT SEISMIC VARIABLES AND PREDICTING HORIZONS

(71) Applicant: Landmark Graphics Corporation, Hoston, TX (US)

(72) Inventors: Marc Paul SERVAIS, Abingdon (GB); Graham BAINES, Abingdon (GB); Daniel James POSSEE, Abingdon (GB)

(21) Appl. No.: 17/138,892

(22) Filed: Dec. 30, 2020

(51) Int. Cl. G06N 20/00

(52) U.S. Cl. CPC G06N 20/00

(57) ABSTRACT

An apparatus for processing seismic data variables comprising a tracking module and an interpretation module. The tracking module selects groupings of subsurface data variables from the seismic data variables, selects a subsurface data variable for each grouping, and determines an isochron variable for each subsurface data variable for each grouping. Each grouping of subsurface data variables has spatial coordinates values. The interpretation module predicts a horizon variable for each grouping using the isochron variable and an algorithmic model or trained algorithmic. The interpretation module predicts a horizon variable using the isochron variable for each grouping and a trained algorithmic model. The tracking module selects the subsurface data variable for each grouping based on a peak, trough or zero-crossing identified in the grouping. The trained algorithmic model uses multivariate classification or multivariate linear regression analysis using the isochron variables and associated seismic data variables against a dataset to predict the horizons.

### BACKGROUND

Seismic data can be used in the gas and oil industry to generate images of subsurface formations. The images can be used by scientists to identify horizons in the subsurface formation. A horizon is a defined interface in a subsurface formation generated in the seismic data when there is a seismic reflection; such as that created in the seismic data where there is contact between two bodies of rock having different seismic characteristics. The horizon or horizons found in the seismic data constrain a geological interpretation that can be used to identify a potential hydrocarbon reservoir in a subsurface formation.

Seismic data generated from commercially available subsurface imaging technology can comprise a large amount of data variables. To identify (“track”) horizons in a subsurface formation and determine if the tracked horizons are indicative of being associated with a hydrocarbon reservoir can be a difficult task. Tracking multiple horizons in seismic data in order to provide a detailed, dense sub-surface interpretation is a time consuming and resource intensive task, particularly when the seismic data contains geological faults.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1A is an illustration of a diagram of a system for processing seismic data variables in order to train an algorithmic model and predict horizons, in accordance with certain example embodiments;

FIG. 1B is an illustration of a diagram of a system for the training module used to generate trained algorithmic models, in accordance with certain example embodiments;

FIG. 2A is an illustration of a seismic image having a tile with a central point A_{C}, in accordance with certain example embodiments;

FIG. 2B is an illustration of an age model for the seismic image having another tile with a central point A_{C}, in accordance with certain example embodiments;

FIG. 3A is an illustration of a binary mask based on an isochron (horizon) through a tile midpoint A_{C} derived from an age model, in accordance with certain example embodiments;

FIG. 3B is an illustration of another binary mask based on the isochron (horizon) through a tile midpoint A_{C} using a slightly wider contour A_{C}+/−δ, in accordance with certain example embodiments;

FIG. 4A is an illustration of a central horizon predicted by a trained algorithmic model, in accordance with certain example embodiments;

FIG. 4B is an illustration of an original horizon illustrated in FIG. 3B, in accordance with certain example embodiments;

FIG. 5 is an illustration of central horizon planes, seismic amplitudes, and a predicted central horizon probability for seismic data generated using 3D imaging technology, in accordance with certain example embodiments;

FIG. 6A is an algorithm for a predictive engine, in accordance with certain example embodiments;

FIG. 6B is an algorithm for a training module, according to certain example embodiments; and

FIG. 7 is an illustration of a diagram of a computing machine and a system applications module, in accordance with certain example embodiments.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

As previously mentioned, tracking multiple horizons simultaneously requires an algorithmic model having a very high degree of complexity and, therefore, can be time consuming and resource intensive. To make these algorithmic models practical for use in a commercial setting, the use of machine learning tools and training data sets to train these highly complex algorithmic models in order to reduce the model's parameter space and using these trained algorithmic models predict multiple horizons in newly generated, or never before seen, seismic data is presented.

Presented herein is a system, method, and apparatus for processing seismic data variables. The apparatus comprises a tracking module and an interpretation module. The tracking module selects groupings of subsurface data variables from the seismic data. Each grouping of subsurface data variables has a plurality of spatial coordinates values. The interpretation module predicts a horizon variable that passes through a predefined spatial coordinates value, such as the central coordinate, within each grouping using an algorithmic model.

In an embodiment, the tracking module can select the subsurface data variable for each grouping based on a peak, trough, or zero-crossing identified in the grouping. The interpretation module can predict the horizon variable using the isochron variable for each grouping and a trained algorithmic model. The trained algorithmic model can be trained using the groupings of subsurface data variables from the seismic data variables and corresponding geological age interpretation variables, the subsurface data variable for each grouping, and the isochron variable for each grouping.

In yet another embodiment, the interpretation module can predict the horizon variable for each grouping using the isochron variable for a respective grouping and a trained algorithmic model. The trained algorithmic model can use classification and linear regression analysis to classify the isochron variable for each grouping based on a plurality of isochron variables and associated seismic data variables in a dataset and strength of relationship of the isochron variable for each grouping with and a plurality of isochron variables in the dataset.

In still yet another embodiment, the interpretation module can predict the horizon variable for each grouping using the isochron variable for a respective grouping and a trained algorithmic model. The trained algorithmic model can generate a range of probability values. The tracking module can determine the corresponding geological age variables based on an interpretation of the seismic data variables. The interpretation module can determine the presence of a hydrocarbon reservoir, a site for carbon storage, a site for hydrogen storage, an aquifer, or a geothermal resource using the predicted horizon variable for each grouping. The interpretation module determines the isochron variable using a corresponding geological age interpretation variable and the subsurface data variable for each grouping or a-priori isochorn variable and the subsurface data variable for each grouping.

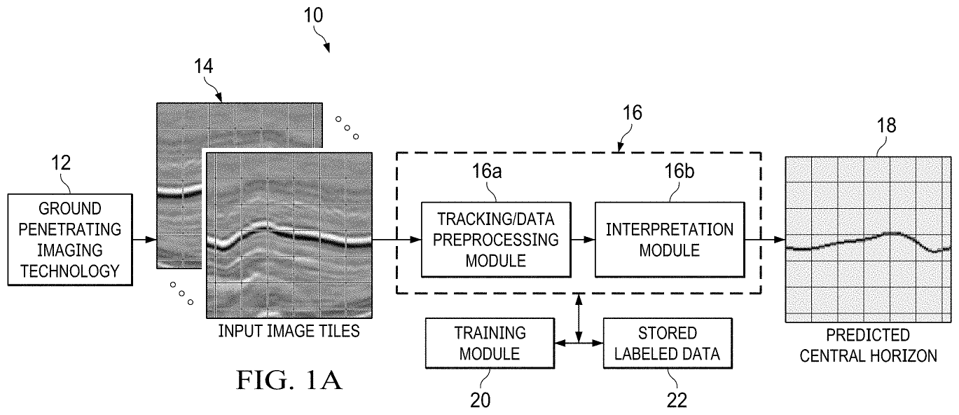

Referring now to FIG. 1A, illustrated is a diagram of a system for processing seismic data variables in order to train an algorithmic model and predict horizons, according to certain example embodiments, denoted generally as 10. Typically, seismic data variables are variables having parameter and value pairing for different geophysical and geological properties that are used to defined a subsurface seismic image. Spatial coordinates and boundary interfaces between layers in an imaged subsurface formation are of particular interest. Values for these variables are typically used to indicate an electromagnetic amplitude. A predicted horizon as used herein is a predictive result that identifies a data point in an image and value representing the probability of the point being part of a central horizon. The process described herein can be used to generate a plurality, i.e. a dense set, of predictive horizons. The predicted horizon, and in particular the dense set, can be used to aid in any seismic interpretation. In the case of the dense set of predictive horizons, the set can be used to predict the presence of hydrocarbons, suitable sites for carbon storage, suitable sites for hydrogen storage, the presence of aquifers, and the presence of geothermal resources, as an example, in a subsurface formation.

The system 10 comprises ground penetrating imaging technology 12, input image tiles 14 generated from the seismic data variables, a predictive engine 16, a predictive result or results 18 generated by the predictive engine 16, a training module 20, and stored labeled data 22. The system 10 generates subsurface seismic data variables, tracks select variables from the subsurface seismic data variables, and generates predictive results identifying horizons in a subsurface formation. Additionally, the system 10 tracks and labels select variables from the subsurface seismic data variables, stores the labeled variables and other information variables, and trains algorithmic models using the stored labeled variables and other information variables.

The predictive engine 16 comprises a tracking and data preprocessing module 16a and an interpretation module 16b. The predictive engine 16 processes seismic data variables generated by the ground penetrating imaging technology 12 and generates predictive results by selecting groupings of subsurface data variables, generating a select data variable for each grouping, determining isochron variable for each select variable, and using an algorithmic model or a trained algorithmic model to generate a predictive result for each grouping.

The tracking and data preprocessing module 16a selects groupings of subsurface data variables based on a predefined tile size from a larger grouping of seismic data variables that define a subsurface seismic image. Each grouping selected from the larger grouping can be described as an image tile. The subsurface data variables associated with a grouping has a defined area or volume with each point in the plane having unique subsurface coordinates. Each grouping, with respect to other groupings, can have different spatial coordinates with a common depth value, different spatial coordinates with a different depth value, same spatial coordinates with a different depth value, partially common spatial coordinates with a common depth value, partially common spatial coordinates with a different depth value, or any combination thereof. For a 2D (2-Dimensional) seismic image, the spatial coordinates include three Cartesians axes (x, y, and z). The z-axis is the depth as measured from the surface and x- and y-axes parallel with the surface. For a 2D seismic image, depending on orientation of the equipment, the variable value for the x-axis or y-axis is zero. For 3D seismic image, the variable describing the x-axis, y-axis, and z-axis has an assigned value. In the case of 3D seismic images, a central plane that runs through a seismic cuboid that forms part of a larger seismic volume is predicted. It should be understood that the coordinates can represent an arbitrary plane through a volume. In addition, it should be understood that the coordinates can have a constant depth with x-y axis varying. Further, it should be understood that it can be beneficial that the 2D image's coordinates are non-planar, i.e. perpendicular directions are not constant.

The tracking and data preprocessing module 16a selects a subsurface data variable for each grouping. The method of selection is a normalization process. The selection of the subsurface data variables is based on a common scale. Stated differently, on a normalized scale, the location of the surface data variable for a grouping, i.e. tile, is common to all groupings. The effect of this is to reduce the complexity of an algorithmic model used to generate a predictive result using the selection of subsurface data variables. The selected subsurface data variable can be a variable describing spatial coordinates of the center, as an example, of the grouping. Additionally, it can be a variable describing spatial coordinates, e.g. the center of the grouping, wherein the coordinates for a particular depth coincide with a peak in amplitude for an interface boundary. Additionally, it can be a variable describing spatial coordinates, e.g. the center of the grouping, wherein the coordinates for a particular depth coincide with a trough in amplitude for an interface boundary. Furthermore, it can be a variable describing spatial coordinates, e.g. the center of the grouping, wherein the coordinates for a particular depth coincide with a zero crossing in amplitude for an interface boundary.

The tracking and data preprocessing module 16a determines an isochron variable for each grouping. The isochron variable for each grouping is determined using corresponding geological age interpretation variables and the subsurface data variable for each grouping. However, in some embodiments, the isochron variable may be determined using a-priori data provided, e.g., by a subject matter expert or from previously processed seismic data variables. The age of the subsurface data variable for each grouping is determined using the corresponding geological age interpretation variables. The isochron variable used herein is a variable that describes an extrapolation of the age of the subsurface data variable based on a defined adjustment of the determined age of the subsurface data variable. In other words, the isochron variable identifies multiple coordinates that includes the selected subsurface data variable as its central coordinate and at least one set of variables that have at least a different z-axis value. Again, stated differently, the isochron variable identifies multiple coordinates for multiple points with all points having a z-intercept that passes through the selected subsurface data variable. In essence, the iscohron variable defines coordinates that define a subsurface layer having a range defined by the z-axis. The geological age interpretation variables can be determined based on expert analysis, biostratigraphy data, or both. The seismic data variables can be generated using an a-priori age model. In this particular case, the ground penetrating imaging technology 12 would not be needed.

The interpretation module 16b uses the isochron variable for each grouping and an algorithmic model or a trained algorithmic model to generate at least one predictive horizon variable for each isochron variable. The trained algorithmic model can be trained using the groupings of subsurface data variables from the seismic data variables and corresponding geological age interpretation variables, the subsurface data variable for each grouping, and the isochron variable for each grouping.

The trained algorithmic model can also use classification, linear regression analysis, e.g. multivariate classification and linear regression analysis, or both to generate predictive horizon variables. Multivariate classification can be used to classify the isochron variable for each grouping based on a plurality of isochron variables and associated seismic data variables in a training dataset. Multivariate linear regression analysis can be used to determine strength of relationship of the isochron variable for each grouping with and a plurality of isochron variables in the training dataset. The predictive results can be probabilistic and, therefore, represented by a range of probability values. A particular type of neural network that can be used to generate predictions using the trained algorithmic model is a convolutional neural network called U-Net.

The tracking and data preprocessing module 16a labels relevant data variables and stores the labeled data variables for use in training algorithmic models. The relevant data variables can include each grouping of the data variables, the seismic data variables associated with the groupings, the selected data variable for each grouping, corresponding age interpretations or corresponding age algorithmic model, and the isocron variable associated with the selected data variable. The interpretation module 16b can store predictive results, accuracy of predictive results (e.g., based on user input), and access trained algorithmic models. In the case of real seismic data, the corresponding age interpretations can be based upon an interpretation by human experts, biostratigraphy data or other interpretation software. Alternatively, synthetic seismic images can be generated from an existing age model. It should be understood, depending on the embodiment, the tracking function of the tracking and data preprocessing module 16a can be operated independently of the data preprocessing function of the tracking and data preprocessing module 16a or they can be operated dependently. The tracking function includes the functionality to identify and label relevant data variables needed for training purposes and the data preprocessing function includes the functionality to identify the data variables needed for predicting horizons.

The training module 20 uses the relevant data variables as a training data set to fit an algorithmic model. With enough training data sets, the algorithmic model can be more accurately fitted and, therefore, have a reduced parameter space that can be used to more efficiently, yet accurately, predict horizon variables in newly generated seismic data. A particular type of neural network that can be used to train the algorithmic model is a convolutional neural network called U-Net. In essence, the method used to train an algorithmic model is similar to how an algorithmic model is used, with the exception that in the latter case, the tests conducted in training are used to identify parameters within the parameter space of an algorithmic model that do not affect an outcome or have insignificant affect.

Referring now to FIG. 1B, illustrated is a diagram of a system for the training module 20 used to generate trained algorithmic models, according to certain example embodiments. The training module 20 processes seismic data variables 22 to create a training data set. The seismic data variables includes data variables that can be used to form subsurface images and corresponding data variables that provide an age of the corresponding formation. A pre-trained algorithmic model having a high dimensional parameter space is then fitted against the training data set in order to generate and identify a trained algorithmic model having a smaller parameter space that can efficiently yet accurately generate predictions.

From the data variables, both image and age based variables, the training module 20 selects groupings of data variables that form image tiles 24 and age model or interpretation tiles 26. For each grouping, the training module 20 selects a particular data variable, such as the central data variable, and determines the isochron variable. In determining the isochron variable, the training module 20 creates a mask, i.e. an array of data points, having the same dimensions as the tile and sets the initial values to zero. It should be understood that data point and data variable are used interchangeable herein. The training module 20 can determine a central point A_{C} by evaluating values representing amplitude in order to determine a peak, trough or zero-crossing. The training module 20 then determines the age, using an age model or interpreted ages, of the central point A_{C} in the tile. The training modules 20 then determines points in the tile having an age in the range [A_{C}−δ, A_{C}+δ] and sets the points in the mask to 1. δ can be some small non-negative age value. The value can be chosen A_{C}+/−δ so that it indicates a thin horizon. However, and as previously stated, the isochron variable can be a-priori data provided by, e.g., a subject matter expert.

As an optional step, the training module 20 determines any remaining data points in the mask without a value of 1 to determine which data points have an age value within a predefined range to the central point A_{C} and set the points in the mask to 1. This can be determined using a predefined threshold. As another optional step, for each image tile and mask used in training, the data variables used as the training data set can be increased in size. The size can be increased by augmenting the original data variables to include a negative version of the seismic image (with the original mask), a left-right flipped version of the seismic image (with a left-right flipped mask), and a left-right flipped negative version of the seismic image (with a left-right flipped negative mask). It should be understood that, instead of masks, up-down flips, rotations, interpolation, transposing, changing the statistical distribution of the data, or any combination thereof.

The training module 20 then uses an algorithmic model trainer 28 to fit an algorithmic model. The algorithmic model trainer 28 uses the algorithmic model to generate predictions 30 and observations about the generated predictions 30. Initially, the algorithmic model has high dimensional parameter space. However, with enough observations, the algorithmic model trainer 28 can generate a trained algorithmic model having a reduced parameter space. The observations can include, as an example, observation of a parameter's dependency on accuracy of predictive results.

The algorithmic model trainer 28 can use classification, linear regression analysis, e.g. multivariate classification, multivariate linear regression analysis, or both to generate predictive horizon variables and observations. Multivariate classification can be used to classify the isochron variable for each grouping based on a plurality of isochron variables and associated seismic data variables in a training dataset. Multivariate linear regression analysis can be used to determine strength of relationship of the isochron variable for each grouping and a plurality of isochron variables in the training dataset. The predictive results can be probabilistic and, therefore, either zero or one. The algorithmic model trainer 28 can be a type of neural network. The neural network used to generate the trained algorithmic model can be a convolutional neural network called U-Net.

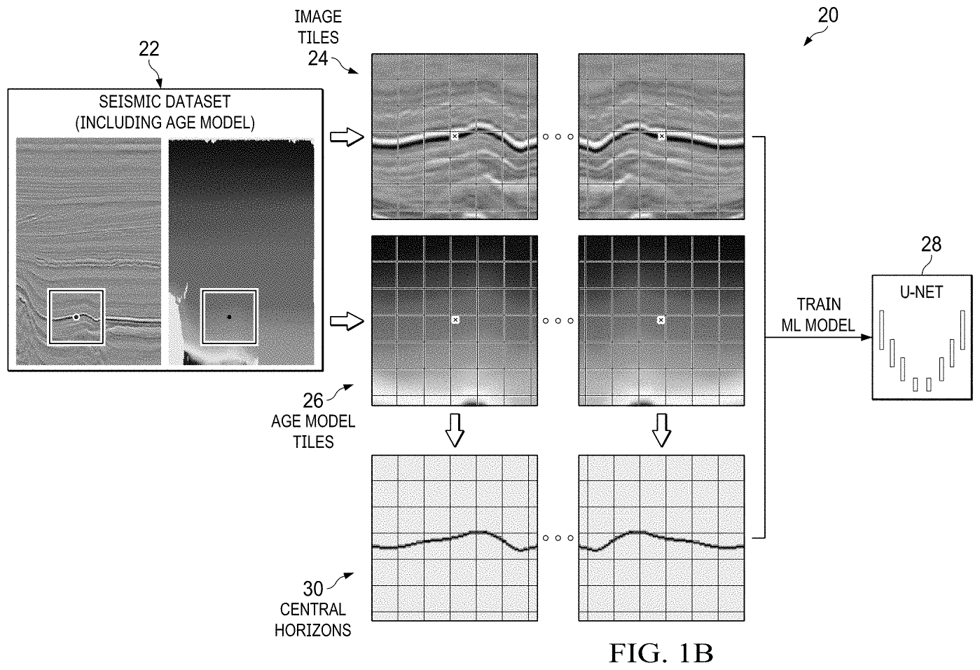

Referring now to FIGS. 2A and 2B, illustrated in FIG. 2A is a seismic image having a tile 38 with a central point A_{C} and in FIG. 2B is an age model for the seismic image having another tile 40 with a central point A_{C}, according to certain example embodiments. As shown in FIGS. 2A and 2B, each seismic image is divided into smaller tiles. The algorithmic model trainer 28 can be configured to track the most well-defined horizons in a seismic image. In this case, the algorithmic model trainer 28 is configured to select the most well-defined horizons, i.e. those having a predefined peak, trough or zero-crossing in seismic amplitude, and create a tile around each well-defined horizon. As an example, image tiles of size 128×128 pixels (samples) can be used; obviously, other dimensions are possible.

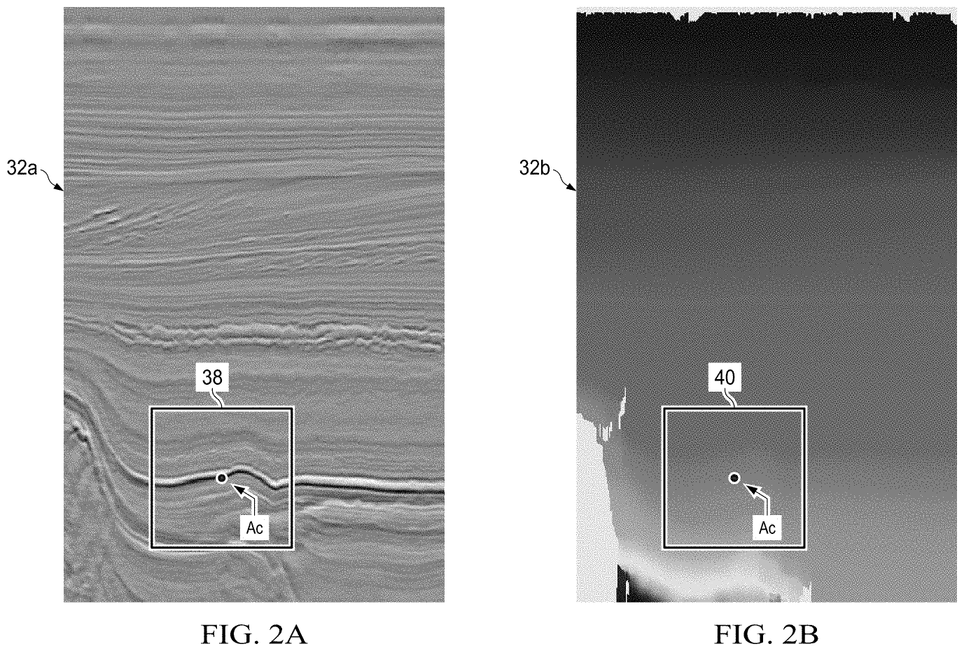

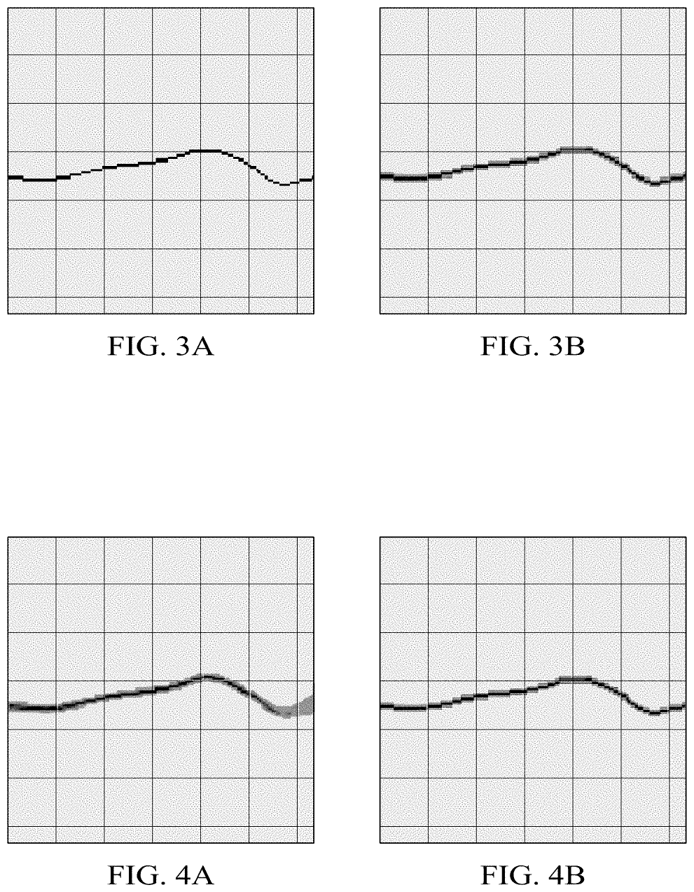

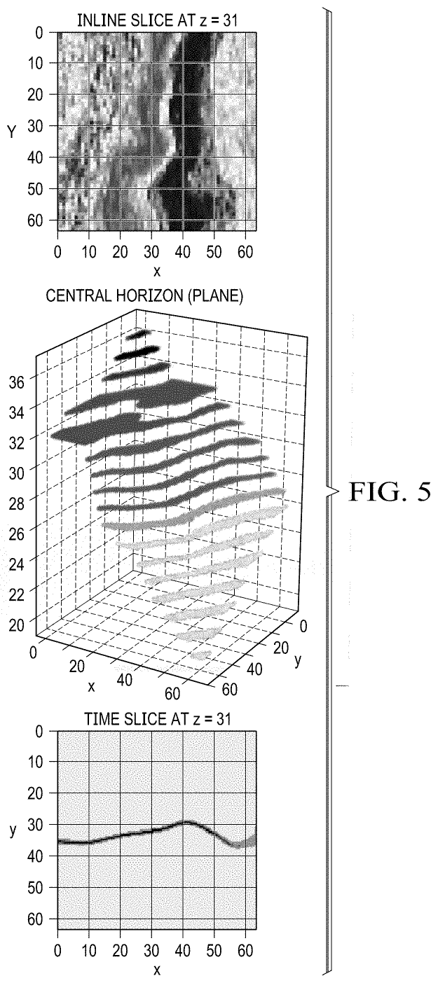

Referring now to FIGS. 3A and 3B, illustrated in FIG. 3A is a binary mask based on the isochron (horizon) through a tile midpoint A_{C} derived from an age model and illustrated in FIG. 3B is another binary mask based on the isochron (horizon) through a tile midpoint A_{C} using a slightly wider contour A_{C}+/−δ, according to certain example embodiments. As can be seen, the mask is no longer binary. Illustrated in FIG. 3A is an example mask, chosen according to the above process (with δ=0). In this case, the horizon has a thickness of one sample (pixel) throughout. It can be beneficial to a learning process to train an algorithmic model with a slightly thicker horizon. When training the model, it can be desirable to reward cases where the predicted horizon is only close to the ground-truth horizon. This can be done by convolving the mask with a vertical filter with weights of the form [α, 1, α], where a is in the range [0, 1]. Illustrated in FIG. 3B is an example of this when using α=0.5. Referring now to FIGS. 4A and 4B, FIG. 4A is a central horizon predicted by a trained algorithmic model and FIG. 4B is the original horizon shown in FIG. 3B. A wide variety of machine learning architectures are possible. In general, a convolutional neural network, and more specifically a UNET, is highly effective. Once trained, the input to the algorithmic model is a seismic image tile and the output is the model's prediction of the central horizon running through the tile, as shown in FIG. 4A. Each value in the predicted mask has the range [0, 1]. In general, the closer the predicted mask is to 1 at any one point, the more confident the model is of its prediction at that point. In addition to the seismic amplitude image, other seismic attributes could be added as inputs (e.g. as additional input channels/components to the neural network). 3D seismic images can also be used. The objective in this particular case is to predict a central plane running through a seismic cuboid that forms part of the larger seismic volume, as illustrated in FIG. 5. Instead of representing the central horizon as one category and the background as another, an alternative representation is to classify the area above the horizon as one category, and the area below the horizon as another category. In this case, one obtains a central horizon segmentation map, as illustrated in FIG. 5.

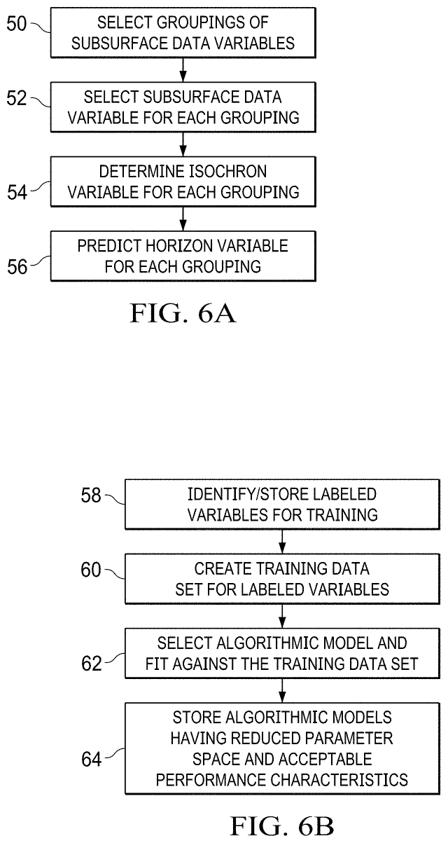

Referring now to FIGS. 6A and 6B, illustrated in FIG. 6A is an algorithm for the predictive engine 16, according to certain example embodiments, and illustrated in FIG. 6B is an algorithm for the training module 20, according to certain example embodiments. The algorithm for the predictive engine 16 begins at block 50. The algorithm for the predictive engine 16 includes data preprocessing functions and horizon prediction functionality. At block 50, groupings of subsurface data variables from the seismic data variables are selected. Each grouping of subsurface data variables has a plurality of spatial coordinates values. At block 52, a subsurface data variable for each grouping is selected. At block 54, an isochron variable for each grouping is determined. The isochron variable can be determined using corresponding geological age interpretation variables and the subsurface data variable for each grouping. Alternatively, the isochron variable can be determined using a-priori information. At block 56, a horizon variable is predicted using the isochron variable for each grouping and an algorithmic model, or trained algorithmic model. It should be understood, depending on the embodiment, that the data preprocessing functions can also include tracking functions, as described in reference to the algorithm for the training module 16, wherein predetermined variables are selected and labeled for training. However, the algorithm for the predictive engine 16 can be executed independently of the tracking function.

The algorithm for the training module 20 begins at block 58 where a data preprocessing step is performed on a set of seismic data variables. At block 58, predetermined variables are identified and labeled. The labeled variables are stored for training purposes. The identified and labeled variables can include data variables associated with a seismic image, groupings of data variables associated with tiles of the seismic image, corresponding age interpretation variables, a corresponding age model, select subsurface data variables, e.g. the midpoint A_{C}, the isochron variables, predictive horizon variables, and accuracy of predictive horizon variables. It should be understood that the seismic data variables can be generated by ground penetrating imaging technology that is processed in real-time. The seismic data variables can be stored data variables previously generated by ground penetrating imaging technology or as an a-priori data source.

At block 60, the training data set or data sets are created from the labeled variables. It should be understood that relevant data variables that have been labeled can come from many sources and from many seismic images. As long as the underlying characteristics of the tiles are similar, the variables can be grouped for training. This can be useful in a cloud services setting where a 3rd party is dedicated to train algorithmic models and provide the trained algorithmic models and training data sets to another party. At block 62, the algorithmic model is then fitted using the training data set or data sets. The algorithmic model is originally designed for a data set of unknown or rather unseen seismic variables. At this step, the parameter space of the algorithmic model is reduced by adapting the parameter space of the algorithmic model according to the following. Tiles within previously before unseen seismic data variables are selected and a particular data variable, such as the central data variable, is selected from the tile. The isochron variable is determined. In determining the isochron variable, a mask, i.e. an array of data points, is created. The array is initialized to have the same dimensions as the tile and sets the initial values to zero. A central point A_{C} is determined by evaluating values representing amplitude in order to determine a peak, trough or zero-crossing. The age, using an age model or age interpretations, of the central point A_{C} in the tile is determined. Points in the tile having an age in the range [A_{C}−δ, A_{C}+δ] are then determined and the points in the mask are set to 1. δ can be some small non-negative age value. The value A_{C}+/−δ can be chosen so that it indicates a thin horizon. The modified algorithmic model can be used to generate predictions and observations about the generated predictions using the data set of unknown seismic variable and the training data set. With enough observations, a trained algorithmic model having a reduced parameter space can be generated. The observations can include, as an example, observation of a parameter's dependency on accuracy of predictive results. Classification, linear regression analysis, e.g. multivariate classification, multivariate linear regression analysis, or both to generate predictive horizon variables and observations can be used. Multivariate classification can be used to classify the isochron variable for each grouping based on a plurality of isochron variables and associated seismic data variables in the data set of unknown seismic variables and the training dataset. Multivariate linear regression analysis can be used to determine strength of relationship of the isochron variable for each grouping with and a plurality of isochron variables in the in the data set of unknown seismic variables and the training dataset. The predictive results can be probabilistic and, therefore, a range of probability values.

The algorithm continues at block 64. At block 64, the algorithm determines if a trained algorithmic model generates predictive results in a manner that satisfies a performance criteria, such as for efficiency and accuracy. Accepted, trained algorithmic models are labeled and stored according to a training data set. The stored algorithmic models and the training data set can be published or otherwise made available in a commercial setting.

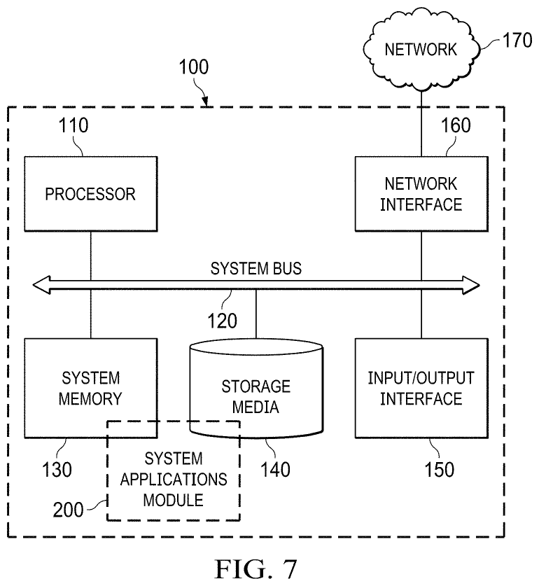

Referring now to FIG. 7, illustrated is a computing machine 100 and a system applications module 200, in accordance with example embodiments. The computing machine 100 can correspond to any of the various computers, mobile devices, laptop computers, servers, embedded systems, or computing systems presented herein. The module 200 can comprise one or more hardware or software elements designed to facilitate the computing machine 100 in performing the various methods and processing functions presented herein. The computing machine 100 can include various internal or attached components such as a processor 110, system bus 120, system memory 130, storage media 140, input/output interface 150, a network interface 160 for communicating with a network 170, e.g. a loopback, local network, wide-area network, cellular/GPS, Bluetooth, WIFI, and WIMAX.

The computing machine 100 can be implemented as a conventional computer system, an embedded controller, a laptop, a server, a mobile device, a smartphone, a wearable computer, a customized machine, any other hardware platform, or any combination or multiplicity thereof. The computing machine 100 and associated logic and modules can be a distributed system configured to function using multiple computing machines interconnected via a data network and/or bus system.

The processor 110 can be designed to execute code instructions in order to perform the operations and functionality described herein, manage request flow and address mappings, and to perform calculations and generate commands. The processor 110 can be configured to monitor and control the operation of the components in the computing machines. The processor 110 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 110 can be a single processing unit, multiple processing units, a single processing core, multiple processing cores, special purpose processing cores, co-processors, or any combination thereof. According to certain embodiments, the processor 110 along with other components of the computing machine 100 can be a software based or hardware based virtualized computing machine executing within one or more other computing machines.

The system memory 130 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 130 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 130. The system memory 130 can be implemented using a single memory module or multiple memory modules. While the system memory 130 is depicted as being part of the computing machine, one skilled in the art will recognize that the system memory 130 can be separate from the computing machine 100 without departing from the scope of the subject technology. It should also be appreciated that the system memory 130 can include, or operate in conjunction with, a non-volatile storage device such as the storage media 140.

The storage media 140 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 140 can store one or more operating systems, application programs and program modules, data, or any other information. The storage media 140 can be part of, or connected to, the computing machine. The storage media 140 can also be part of one or more other computing machines that are in communication with the computing machine such as servers, database servers, cloud storage, network attached storage, and so forth.

The applications module 200 can comprise one or more hardware or software elements configured to facilitate the computing machine with performing the various methods and processing functions presented herein. The applications module 200 can include one or more algorithms or sequences of instructions stored as software or firmware in association with the system memory 130, the storage media 140 or both. The storage media 140 can therefore represent examples of machine or computer readable media on which instructions or code can be stored for execution by the processor 110. Machine or computer readable media can generally refer to any medium or media used to provide instructions to the processor 110. Such machine or computer readable media associated with the applications module 200 can comprise a computer software product. It should be appreciated that a computer software product comprising the applications module 200 can also be associated with one or more processes or methods for delivering the applications module 200 to the computing machine 100 via a network, any signal-bearing medium, or any other communication or delivery technology. The applications module 200 can also comprise hardware circuits or information for configuring hardware circuits such as microcode or configuration information for an FPGA or other PLD. In one exemplary embodiment, applications module 100 can include algorithms capable of performing the functional operations described by the flow charts and computer systems presented herein.

The input/output (“I/O”) interface 150 can be configured to couple to one or more external devices, to receive data from the one or more external devices, and to send data to the one or more external devices. Such external devices along with the various internal devices can also be known as peripheral devices. The I/O interface 150 can include both electrical and physical connections for coupling the various peripheral devices to the computing machine or the processor 110. The I/O interface 150 can be configured to communicate data, addresses, and control signals between the peripheral devices, the computing machine, or the processor 110. The I/O interface 150 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 150 can be configured to implement only one interface or bus technology. Alternatively, the I/O interface 150 can be configured to implement multiple interfaces or bus technologies. The I/O interface 150 can be configured as part of, all of, or to operate in conjunction with, the system bus 120. The I/O interface 150 can include one or more buffers for buffering transmissions between one or more external devices, internal devices, the computing machine, or the processor 120.

The I/O interface 120 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 120 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine 100 can operate in a networked environment using logical connections through the network interface 160 to one or more other systems or computing machines across a network. The network can include wide area networks (WAN), local area networks (LAN), intranets, the Internet, wireless access networks, wired networks, mobile networks, telephone networks, optical networks, or combinations thereof. The network can be packet switched, circuit switched, of any topology, and can use any communication protocol. Communication links within the network can involve various digital or an analog communication media such as fiber optic cables, free-space optics, waveguides, electrical conductors, wireless links, antennas, radio-frequency communications, and so forth.

The processor 110 can be connected to the other elements of the computing machine or the various peripherals discussed herein through the system bus 120. It should be appreciated that the system bus 120 can be within the processor 110, outside the processor 110, or both. According to some embodiments, any of the processors 110, the other elements of the computing machine, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, an apparatus for processing seismic data variables, the apparatus comprising: a tracking module configured by a processor to: select groupings of subsurface data variables from the seismic data variables, each grouping of subsurface data variables having a plurality of spatial coordinates values; select a subsurface data variable for each grouping; determine an isochron variable for each grouping and the subsurface data variable for each grouping; an interpretation module configured by a processor to: predict a horizon variable for each grouping using the isochron variable and an algorithmic model;

Clause 2, the apparatus of clause 1, further comprising the tracking module configured by the processor to select the subsurface data variable for each grouping based on a peak, trough, or zero crossing identified in the grouping;

Clause 3, the apparatus of clause 1, further comprising the interpretation module configured by the processor to: predict the horizon variable using the isochron variable for each grouping and a trained algorithmic model;

Clause 4, the apparatus of clause 1, further comprising the interpretation module configured by the processor to: predict the horizon variable using the isochron variable for each grouping and a trained algorithmic model, the trained algorithmic model trained using the groupings of subsurface data variables from the seismic data variables and corresponding geological age interpretation variables, the subsurface data variable for each grouping, and the isochron variable for each grouping;

Clause 5, the apparatus of clause 1, further comprising the interpretation module configured by the processor to: predict the horizon variable using the isochron variable for each grouping and a trained algorithmic model; and the trained algorithmic model uses classification and linear regression analysis to classify the isochron variable for each grouping based on a plurality of isochron variables and associated seismic data variables in a dataset and strength of relationship of the isochron variable for each grouping and a plurality of isochron variables in the dataset;

Clause 6, the apparatus of clause 1, further comprising the interpretation module configured by the processor to: predict the horizon variable using the isochron variable for each grouping and a trained algorithmic model, the trained algorithmic model generates a range of probability values;

Clause 7, the apparatus of clause 1, further comprising the interpretation module configured by the processor to determine the presence of a hydrocarbon reservoir, a site for carbon storage, a site for hydrogen storage, an aquifer, or a geothermal resource using the predicted horizon variable for each grouping;

Clause 8, the apparatus of clause 1, further comprising the interpretation module configured by the processor to determine the isochron variable using a corresponding geological age interpretation variable and the subsurface data variable for each grouping or a-priori isochorn variable and the subsurface data variable for each grouping;

Clause 9, a system for predicting a horizon, the system comprising: a ground penetrating imaging device for generating seismic data variables; a tracking module configured by a processor to: select groupings of subsurface data variables from the seismic data variables, each grouping of subsurface data variables having a plurality of spatial coordinates values; select a subsurface data variable for each grouping; determine an isochron variable for each grouping and the subsurface data variable for each grouping; an interpretation module configured by a processor to: predict a horizon variable for each grouping using the isochron variable and an algorithmic model; a display module configured by a processor to: generate a display comprising the predicted horizon variable;

Clause 10, the system of clause 9, further comprising the tracking module configured by the processor to select the subsurface data variable for each grouping based on a peak, trough, or zero crossing identified in the grouping;

Clause 11, the system of clause 9, further comprising the interpretation module configured by the processor to: predict the horizon variable using the isochron variable for each grouping and a trained algorithmic model;

Clause 12, the system of clause 9, further comprising the interpretation module configured by the processor to: predict the horizon variable using the isochron variable for each grouping and a trained algorithmic model, the trained algorithmic model trained using the groupings of subsurface data variables from the seismic data variables and corresponding geological age interpretation variables, the subsurface data variable for each grouping, and the isochron variable for each grouping;

Clause 13, the system of clause 9, further comprising the interpretation module configured by the processor to: predict the horizon variable using the isochron variable for each grouping and a trained algorithmic model; and the trained algorithmic model uses classification and linear regression analysis to classify the isochron variable for each grouping based on a plurality of isochron variables and associated seismic data variables in a dataset and strength of relationship of the isochron variable for each grouping and a plurality of isochron variables in the dataset;

Clause 14, the system of clause 9, further comprising the interpretation module configured by the processor to: predict the horizon variable using the isochron variable for each grouping and a trained algorithmic model, the trained algorithmic model generates a range of probability values;

Clause 15, a method for processing seismic data variables, the method comprising: selecting groupings of subsurface data variables from the seismic data variables, each grouping of subsurface data variables having a plurality of spatial coordinates values; selecting a subsurface data variable for each grouping; determining an isochron variable for each grouping using the subsurface data variable for each grouping; and predicting a horizon variable for each grouping using the isochron variable and an algorithmic model;

Clause 16, the method of clause 15, further comprising selecting the subsurface data variable for each grouping based on a peak, trough, or zero crossing identified in the grouping;

Clause 17, the method of clause 15, further comprising predicting the horizon variable using the isochron variable for each grouping and a trained algorithmic model;

Clause 18, the method of clause 15, further comprising predicting the horizon variable using the isochron variable for each grouping and a trained algorithmic model, the trained algorithmic model trained using the groupings of subsurface data variables from the seismic data variables and corresponding geological age interpretation variables, the subsurface data variable for each grouping, and the isochron variable for each grouping;

Clause 19, the method of clause 15, further comprising: predicting the horizon variable using the isochron variable for each grouping and a trained algorithmic model; and using, by the trained algorithmic model, classification and linear regression analysis to classify the isochron variable for each grouping based on a plurality of isochron variables and associated seismic data variables in a dataset and strength of relationship of the isochron variable for each grouping with and a plurality of isochron variables in the dataset; and

Clause 20, the method of clause 15, predicting the horizon variable using the isochron variable for each grouping and a trained algorithmic model, the trained algorithmic model generates a range of probability values.

What is claimed is:

1. An apparatus for processing seismic data variables, the apparatus comprising:
a tracking module configured by a processor to:
select groupings of subsurface data variables from the seismic data variables, each grouping of subsurface data variables having a plurality of spatial coordinates values;
select a subsurface data variable for each grouping;
determine an isochron variable for each grouping and the subsurface data variable for each grouping;
an interpretation module configured by a processor to: predict a horizon variable for each grouping using the isochron variable and an algorithmic model.

2. The apparatus of claim 1, further comprising the tracking module configured by the processor to select the subsurface data variable for each grouping based on a peak, trough, or zero crossing identified in the grouping.

3. The apparatus of claim 1, further comprising the interpretation module configured by the processor to: predict the horizon variable using the isochron variable for each grouping and a trained algorithmic model.

4. The apparatus of claim 1, further comprising the interpretation module configured by the processor to: predict the horizon variable using the isochron variable for each grouping and a trained algorithmic model, the trained algorithmic model trained using the groupings of subsurface data variables from the seismic data variables and corresponding geological age interpretation variables, the subsurface data variable for each grouping, and the isochron variable for each grouping.

5. The apparatus of claim 1, further comprising the interpretation module configured by the processor to:
predict the horizon variable using the isochron variable for each grouping and a trained algorithmic model; and
the trained algorithmic model uses classification and linear regression analysis to classify the isochron variable for each grouping based on a plurality of isochron variables and associated seismic data variables in a dataset and strength of relationship of the isochron variable for each grouping and a plurality of isochron variables in the dataset.

6. The apparatus of claim 1, further comprising the interpretation module configured by the processor to: predict the horizon variable using the isochron variable for each grouping and a trained algorithmic model, the trained algorithmic model generates a range of probability values.

7. The apparatus of claim 1, further comprising the interpretation module configured by the processor to determine the presence of a hydrocarbon reservoir, a site for carbon storage, a site for hydrogen storage, an aquifer, or a geothermal resource using the predicted horizon variable for each grouping.

8. The apparatus of claim 1, further comprising the interpretation module configured by the processor to determine the isochron variable using a corresponding geological age interpretation variable and the subsurface data variable for each grouping or a-priori isochorn variable and the subsurface data variable for each grouping.

9. A system for predicting a horizon, the system comprising:
a ground penetrating imaging device for generating seismic data variables;
a tracking module configured by a processor to:
select groupings of subsurface data variables from the seismic data variables, each grouping of subsurface data variables having a plurality of spatial coordinates values;
select a subsurface data variable for each grouping;
determine an isochron variable for each grouping and the subsurface data variable for each grouping;
an interpretation module configured by a processor to: predict a horizon variable for each grouping using the isochron variable and an algorithmic model;
a display module configured by a processor to: generate a display comprising the predicted horizon variable.

10. The system of claim 9, further comprising the tracking module configured by the processor to select the subsurface data variable for each grouping based on a peak, trough, or zero crossing identified in the grouping.

11. The system of claim 9, further comprising the interpretation module configured by the processor to: predict the horizon variable using the isochron variable for each grouping and a trained algorithmic model.

12. The system of claim 9, further comprising the interpretation module configured by the processor to: predict the horizon variable using the isochron variable for each grouping and a trained algorithmic model, the trained algorithmic model trained using the groupings of subsurface data variables from the seismic data variables and corresponding geological age interpretation variables, the subsurface data variable for each grouping, and the isochron variable for each grouping.

13. The system of claim 9, further comprising the interpretation module configured by the processor to:
predict the horizon variable using the isochron variable for each grouping and a trained algorithmic model; and
the trained algorithmic model uses classification and linear regression analysis to classify the isochron variable for each grouping based on a plurality of isochron variables and associated seismic data variables in a dataset and strength of relationship of the isochron variable for each grouping and a plurality of isochron variables in the dataset.

14. The system of claim 9, further comprising the interpretation module configured by the processor to: predict the horizon variable using the isochron variable for each grouping and a trained algorithmic model, the trained algorithmic model generates a range of probability values.

15. A method for processing seismic data variables, the method comprising:
selecting groupings of subsurface data variables from the seismic data variables, each grouping of subsurface data variables having a plurality of spatial coordinates values;
selecting a subsurface data variable for each grouping;
determining an isochron variable for each grouping using the subsurface data variable for each grouping; and
predicting a horizon variable for each grouping using the isochron variable and an algorithmic model.

16. The method of claim 15, further comprising selecting the subsurface data variable for each grouping based on a peak, trough, or zero crossing identified in the grouping.

17. The method of claim 15, further comprising predicting the horizon variable using the isochron variable for each grouping and a trained algorithmic model.

18. The method of claim 15, further comprising predicting the horizon variable using the isochron variable for each grouping and a trained algorithmic model, the trained algorithmic model trained using the groupings of subsurface data variables from the seismic data variables and corresponding geological age interpretation variables, the subsurface data variable for each grouping, and the isochron variable for each grouping.

19. The method of claim 15, further comprising:
predicting the horizon variable using the isochron variable for each grouping and a trained algorithmic model; and
using, by the trained algorithmic model, classification and linear regression analysis to classify the isochron variable for each grouping based on a plurality of isochron variables and associated seismic data variables in a dataset and strength of relationship of the isochron variable for each grouping with and a plurality of isochron variables in the dataset.

20. The method of claim 15, predicting the horizon variable using the isochron variable for each grouping and a trained algorithmic model, the trained algorithmic model generates a range of probability values.
